(19) United States
(12) Patent Application Publication
(10) Pub. No.: US 2008/0180745 A1
(43) Pub. Date: Jul. 31, 2008

(54) IMAGE FORMING APPARATUS AND IMAGE PROCESSING OPERATIONAL CONTROL METHOD

(75) Inventor: Jun Nakayoshi, Izunokuni-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/668,576

(22) Filed: Jan. 30, 2007

(51) Int. Cl. H04N 1/00

(52) U.S. Cl. 358/1.16

(57) ABSTRACT

An image forming apparatus according to an aspect of the invention comprises a scanning unit configured to scan an image, a receiving unit configured to receive image data, a storing unit configured to store image data obtained by the scanning by the scanning unit and image data received by the receiving unit, an image forming unit configured to form an image on the basis of the image data stored in the storing unit, a connecting unit configured to connect an external storage device, an operation inputting unit configured to accept and input operation of image processing desired by a user and various kinds of information, a designating unit configured to designate one of the storing unit and the external storage device connected by the connecting unit, and a restricting unit configured to restrict predetermined image processing when the external storage device is designated by the designating unit.

### BACKGROUND OF THE INVENTION

1. Field of the Invention

The present invention relates to image forming apparatuses that are capable of performing various kinds of image formation such as a copier, a printer, and a FAX. The present invention also relates to an image processing operational control method applied to these image forming apparatuses.

2. Description of the Related Art

In recent years, various image forming apparatuses represented by an MFP (Multifunction Printer) are spread. The MFP can collectively treat image data digitized by various functions such as a copier, a printer, a scanner, and a FAX, temporarily store these image data in a storage medium such as an HDD, and reuse the image data. The HDD can store not only the image data but also various management information.

When troubles of the HDD are assumed, it is necessary to save data stored in the HDD. In JP-A-2001-34447 (Patent Document 1), a technique for saving internal data stored in the inside of an image forming apparatus is disclosed. More specifically, when the necessity occurs to temporarily save, on the outside of the image forming apparatus, internal data such as various operation parameters, user set data, operation record data, and various counters stored in the inside of the image forming apparatus, for example, when a battery for a memory backed up by the battery is replaced, when a necessity for replacing a printed board mounted with a memory occurs, or when the image forming apparatus itself is replaced because of purchase of a new image forming apparatus, a portable personal computer (a portable terminal apparatus) such as a notebook personal computer is connected to the image forming apparatus and internal data is saved in a storage device of this portable terminal apparatus.

In JP-A-2005-229146 (Patent Document 2), a technique for saving internal data stored in the inside of a communication control apparatus is disclosed. More specifically, a communication control apparatus having a program for communication control and data for various kinds of control held in a storage device (e.g., a ROM, a RAM, or an HDD) in the inside thereof is disclosed. This communication control apparatus outputs the internal data to an external storage device connected thereto via a USB connector and this external storage device backs up the internal data.

### BRIEF SUMMARY OF THE INVENTION

It is an object of the invention to provide an image forming apparatus and an image processing operational control method that enable an operation using an external storage device with a relatively small capacity even in a state in which a large capacity storage device mounted on the image forming apparatus is unusable.

An image forming apparatus according to an aspect of the invention comprises a scanning unit configured to scan an image, a receiving unit configured to receive image data, a storing unit configured to store image data obtained by the scanning by the scanning unit and image data received by the receiving unit, an image forming unit configured to form an image on the basis of the image data stored in the storing unit, a connecting unit configured to connect an external storage device, an operation inputting unit configured to accept and input operation of image processing desired by a user and various kinds of information, a designating unit configured to designate one of the storing unit and the external storage device connected by the connecting unit, and a restricting unit configured to restrict predetermined image processing when the external storage device is designated by the designating unit.

An image processing operational control method according to another aspect of the invention comprises restricting predetermined image processing when, out of an internal storage device and an external storage device, the external storage device is designated.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a schematic structure of an image forming apparatus (an MFP) according to an embodiment of the invention; and

FIG. 2 is a flowchart for explaining processing for switching an HDD to an external storage device and restriction of an image processing operation.

### DETAILED DESCRIPTION OF THE INVENTION

An embodiment will be explained with reference to the drawings.

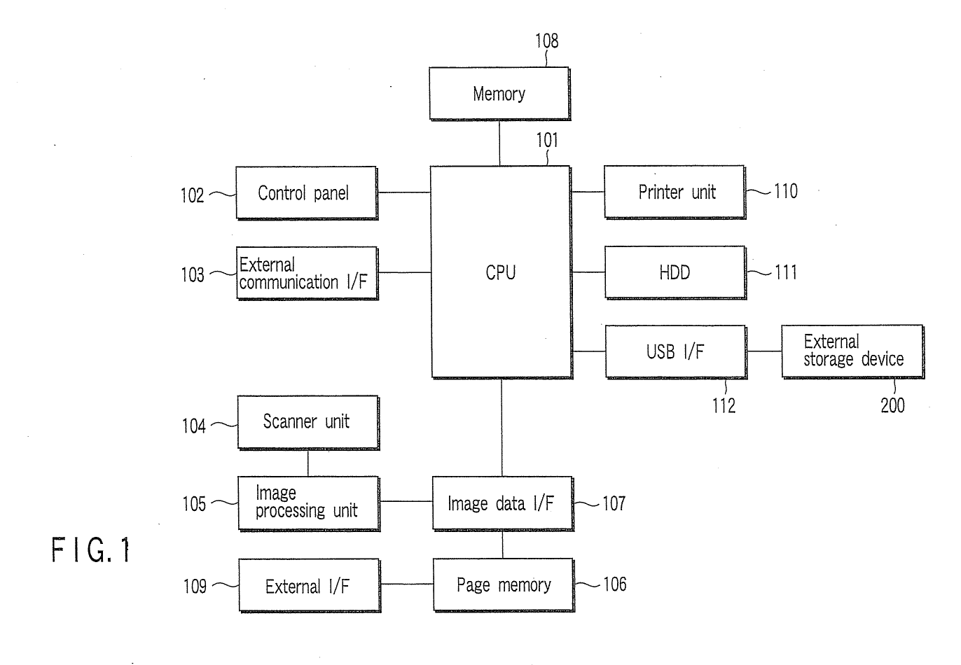

FIG. 1 is a diagram showing a schematic structure of an image forming apparatus (an MFP) according to this embodiment.

A CPU 101 that controls the entire image forming apparatus scans, in response to a print request from a user sent through a control panel 102 or an external communication interface (I/F) 103, an image with a scanner unit 104 when it is necessary to scan the image, subjects image data obtained by the scanning of the image to image processing with an image processing unit 105, and stores the image data subjected to the image processing in a page memory 106. These kinds of processing are controlled by the CPU 101 through an image data interface (I/F) 107. When data is processed by the CPU 101, the data is stored in a memory 108 (a nonvolatile memory) as required. Image data transferred via an external I/F 109 is also stored in the page memory 106. The image data stored in the page memory 106 is sent to a printer unit 110 via the image data I/F 107 and the CPU 101. The printer unit 110 forms an image based on the image data. In other words, the printer unit 110 records the image based on the image data on a sheet.

The image forming apparatus includes a hard disk drive (HDD) 111 as an internal storage device. It is possible to store image data obtained by scanning of an image by the scanner unit 104 and image data transferred via the external I/F 109 and reuse these image data as required. The HDD 111 can store not only image data but also work data and management information.

Moreover, the image forming apparatus includes a USB I/F 112 that connects an external storage device 200 such as a USB memory. The CPU 101 designates one of the HDD 111 and the external storage device 200 and causes the storage destination designated to store image data. For example, when abnormality of the HDD 111 is detected and it is detected that the external storage device 200 is connected via the USB I/F 112, the CPU 101 designates the external storage device 200 and causes the external storage device 200 to store image data. Further, the CPU 101 restricts predetermined image processing (a function or a job) when the external storage device 200 is designated. The CPU 101 can not only cause, instead of the HDD 111, the USB memory to store image data but also cause the external storage device 200 to store work data and management information.

In other words, the image forming apparatus can use, as a substitute for the HDD 111, the external storage device 200 connected to the USB I/F 112. In this embodiment, it is assumed that a storage capacity of the external storage device 200 is small compared with a storage capacity of the HDD 111. Because of this difference of the capacities, it is difficult to enable operations of all functions of the image forming apparatus when the external storage device 200 is selected. Thus, when the external storage device 200 is selected, functions and performance of the image forming apparatus are restricted.

The image forming apparatus described above satisfies the following conditions.
The HDD 111 stores work data in addition to image data.
Management information necessary for a basic operation of the external storage device 200 such as the USB memory is stored in the memory 108 (NVRAM) rather than the HDD 111.
Operation is accepted by the control panel 102.

Control software of the CPU 101 of the image forming apparatus has flags A and B.
The flag A is a flag for determining switching of the HDD 111 and the external storage device 200. When a value of the flag A is 0, the flag A indicates selection (use) of the HDD 111. When a value of the flag A is 1, the flag A indicates selection (use) of the external storage device 200.
The flag B is a flag indicating an executable function or job when a value of the flag A is 1 (i.e., the external storage device 200 is selected). For example, when there are sixty-four kinds of functions or jobs in total, the flag B is formed by data of at least 64 bits (8 bytes). A value of each of the bits corresponds to each function or each job. It is possible to identify an executable function or job according to whether a value of each of the bits is 1 or 0.

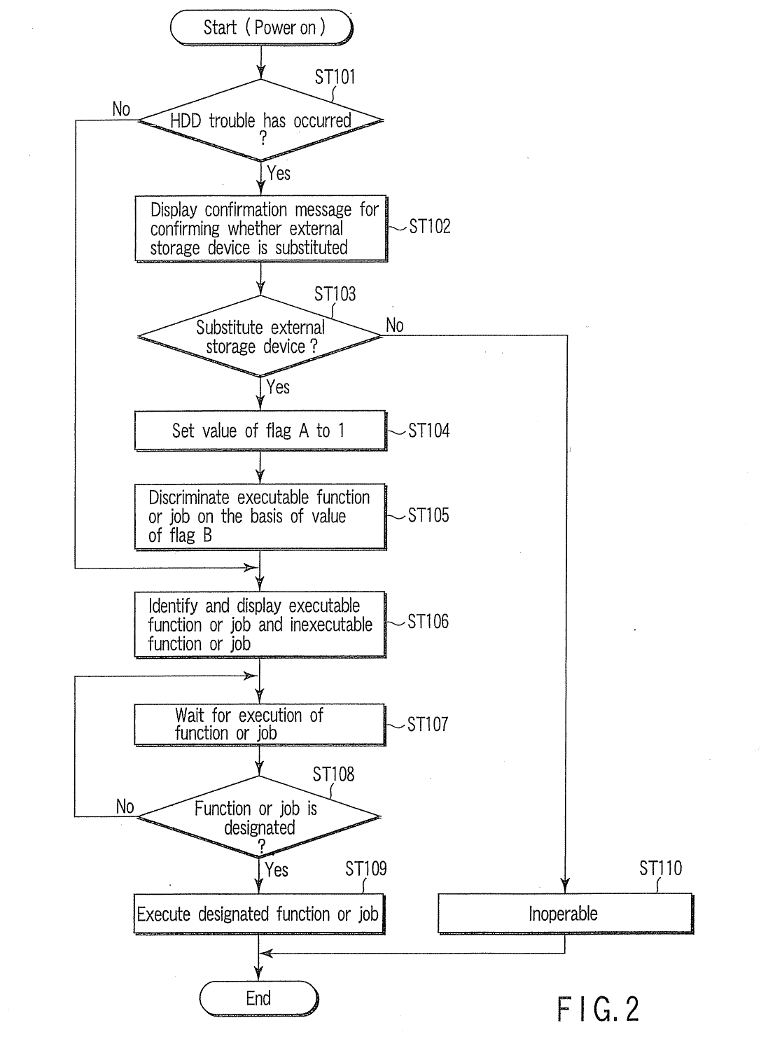

FIG. 2 is a flowchart for explaining processing for switching the HDD 111 to the external storage device 200 and restriction of an image processing operation. For example, when the CPU 101 detects failure of the HDD 111 when the HDD 111 is initialized (ST101, YES), the control panel 102 displays a confirmation message for confirming whether the external storage device 200 such as the USB memory is substituted for the HDD 111 (ST102).

When the user does not input an instruction for substitution of the external storage device 200 such as the USB memory to the control panel 102 (ST103, NO) and time is out, inoperability is displayed on the control panel 102 (ST110). When the user inputs an instruction for substitution of the external storage device 200 such as the USB memory to the control panel 102 (ST103, YES), a value of the flag A is set to 1 (ST104). An executable function or job is discriminated on the basis of a value of the flag B (ST105) and an executable function or job and inexecutable function or job is identified and displayed on the control panel 102 (ST106). The CPU 101 comes into a state of wait for execution of a function or a job (ST107).

The control panel 102 displays one or plural items corresponding to the executable function or job (an image processing function not restricted by the CPU 101) in a first display format (normal). The control panel 102 displays one or plural items corresponding to the inexecutable function or job (an image processing function restricted by the CPU 101) in a second display format (dim) different from the first display format. The control panel 102 accepts operation for selecting a predetermined item displayed in the first display format but does not accept operation for selecting a predetermined item displayed in the second display format. When a predetermined function or job is accepted via the control panel 102 (ST108, YES), the function or the job accepted is executed (ST109).

In the above explanation, the case in which the external storage device 200 is used because of failure of the HDD 111 is explained. However, the external storage device 200 may be used according to a user designation regardless of a state of the HDD 111.

An example of restriction of a function or a job will be explained.

(1) The image forming apparatus according to this embodiment prohibits image processing that requires a storage capacity exceeding a predetermined storage capacity, for example, when the external storage device 200 is designated. Consequently, it is possible to prevent an error due to a shortage of a capacity of the external storage device 200 in advance. For example, the image forming apparatus prohibits a printout based on data exceeding 10 MB. Therefore, when the image forming apparatus executes a print job for receiving image data via the external communication I/F 103 and printing out the image data, the image forming apparatus rejects this print job if it is found that the image data received exceeds 10 MB. The image forming apparatus may detects a storage capacity of the external storage device 200 and determine the predetermined storage capacity on the basis of this storage capacity of the external storage device 200.

(2) The image forming apparatus according to this embodiment prohibits a high-resolution scan mode, for example, when the external storage device 200 is designated. Consequently, it is possible to prevent an error due to a shortage of a capacity of the external storage device 200 in advance. The scanner unit 104 scans an image in a designated mode of first and second scanning modes. The first scanning mode is a mode for scanning an image at a first resolution (e.g., 200 dpi) and storing the image. The second scanning mode is a mode for scanning an image at a second resolution (e.g., 400 dpi) higher than the first resolution and storing the image. The CPU 101 prohibits scanning of an image in the second scanning mode when the external storage device 200 is designated.

(3) The image forming apparatus according to this embodiment prohibits an image formation mode for keeping storage of image data, for example, when the external storage device 200 is designated. Consequently, it is possible to prevent an error due to a shortage of a capacity of the external storage device 200 in advance. The printer unit 110 forms an image in a designated mode of first and second image formation modes. The first image formation mode is a mode for forming, while scanning an image with the scanner unit 104, an image on the basis of image data obtained by this scanning and not requiring storage of the obtained image data after the image formation (even if the image data is stored, overwriting on the image data stored is not prohibited). The second image formation mode is a mode for forming, while scanning an image with the scanner unit 104, an image on the basis of image data obtained by this scanning and requiring storage of the obtained image data even after the image formation (the image data is stored and overwriting on the image data stored is prohibited). The CPU 101 prohibits image formation in the second image formation mode when the external storage device 200 is designated.

(4) The image forming apparatus according to this embodiment scans images from a series of plural originals set on an original stand, for example, when the external storage device 200 is designated and, after scanning all the original images (storing image data of all the original images), prohibits an image formation mode for printing. Consequently, it is possible to prevent an error due to a shortage of a capacity of the external storage device 200 in advance. The printer unit 110 forms an image in a designated mode of first and second image formation modes. The first image formation mode is a mode for forming, while scanning images from a series of plural originals set on an original stand of the scanner unit 104, images on the basis of image data corresponding to the series of plural originals obtained by this scanning and not requiring storage of the obtained image data of the series of plural originals after the image formation (even if the image data is stored, overwriting on the image data stored is not prohibited). The second image formation mode is a mode for scanning images from a series of plural originals set on the scanner unit 104 and forming, after storing image data corresponding to the series of plural originals obtained by this scanning, images of the series of plural originals on the basis of the image data corresponding to the series of plural originals stored. As a further specific example, the first image formation mode is a mode for outputting image data scanned from one original to one sheet and the second image formation mode is a mode for reducing image data scanned from plural originals and outputting the image data to one sheet (a so-called 2-in-1 mode or 4-in-1 mode). The CPU 101 prohibits image formation in the second image formation mode when the external storage device 200 is designated.

(5) The image forming apparatus according to this embodiment prohibits an image formation mode for scanning and printing left and right pages of a book with the left and the right pages divided, for example, when the external storage device 200 is designated. Consequently, it is possible to prevent an error due to a shortage of a capacity of the external storage device 200 in advance. The printer unit 110 forms an image in a designated mode of first and second image formation modes. The first image formation mode is a mode for forming, while scanning an image with the scanner unit 104, an image on the basis of image data obtained by this scanning and not requiring storage of the obtained image data after the image formation. The second image formation mode is a mode for forming, after repeating, a designated number of times, divisional scanning for scanning one original image (left and right pages of a book) set on the original stand of the scanner unit 104 with the original image divided into two (scanning the left page and the right page, respectively) and storing first and second image data (image data of the left page and image data of the right page) corresponding to one original image obtained by this scanning, an image on the basis of the image data stored according to the repetition of the divisional scanning for the designated number of times. The CPU 101 prohibits image formation in the second image formation mode when the external storage device 200 is designated.

(6) The image forming apparatus according to this embodiment prohibits a schedule print for performing printing at a designated time, for example, when the external storage 200 is designated. Consequently, it is possible to prevent an error due to a shortage of a capacity of the external storage device 200 in advance. The printer unit 110 forms an image in a designated mode of first and second image formation modes. The first image formation mode is a mode for forming an image on the basis of image data received by the external communication I/F 103 and not requiring storage of the received image data after the image formation. The second image formation mode is a mode for forming, after storing image data received by the external communication I/F 103, an image on the basis of the stored image data at a designated time included in control information received by the external communication I/F 103 as well. The CPU 101 prohibits image formation in the second image formation mode when the external storage device 200 is designated.

(7) The image forming apparatus according to this embodiment prohibits a private print requiring user authentication, for example, when the external storage device 200 is designated. Consequently, it is possible to prevent an error due to a shortage of a capacity of the external storage device 200 in advance. The printer unit 110 forms an image in a designated mode of first and second image formation modes. The first image formation mode is a mode for forming, without requiring user authentication, an image on the basis of image data received by the external communication I/F 103 and not requiring storage of the received image data after the image formation. The second image formation mode is a mode for forming, after storing image data received by the external communication I/F 103, an image on the basis of the stored image data with user authentication by input of user authentication information through the control panel 102 as a condition. The CPU 101 prohibits image formation in the second image formation mode when the external storage device 200 is designated.

It may be determined on the basis of a storage capacity of the external storage device 200 which image processing of the various kinds of image processing described above should be prohibited and which image processing should be permitted.

According to this image forming apparatus, the following operational effects are obtained.

(1) It is possible to use the image forming apparatus in a manner of a temporary measure by restricting functions and performance in a period from the time when the internal storage device (HDD) is broken down until a service engineer solves the failure of the internal storage device.

(2) It is possible to prevent work data and the like from being left in the inside of the image forming apparatus by using an external storage device (by removing and carrying away the external storage device) even if security measures such as an overwriting clearing function is not applied to the internal storage device (HDD).

(3) The service engineer is capable of easily carrying back work data and the like for trouble check.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a scanning unit configured to scan an image;
a receiving unit configured to receive image data;
a storing unit configured to store image data obtained by the scanning by the scanning unit and image data received by the receiving unit;
an image forming unit configured to form an image on the basis of the image data stored in the storing unit;
a connecting unit configured to connect an external storage device;
an operation inputting unit configured to accept and input operation of image processing desired by a user and various kinds of information;
a designating unit configured to designate one of the storing unit and the external storage device connected by the connecting unit; and
a restricting unit configured to restrict predetermined image processing when the external storage device is designated by the designating unit.

2. An image forming apparatus according to claim 1, wherein the restricting unit prohibits, when the external storage device is designated, image processing requiring a storage capacity exceeding a predetermined storage capacity.

3. An image forming apparatus according to claim 1, wherein
the scanning unit scans an image in a designated mode of first and second scanning modes,
the restricting unit prohibits scanning of an image in the second scanning mode when the external storage device is designated,
the first scanning mode is a mode for scanning an image at a first resolution and storing the image, and
the second scanning mode is a mode for scanning an image at a second resolution higher than the first resolution and storing the image.

4. An image forming apparatus according to claim 1, wherein
the image forming unit forms an image in a designated mode of first and second image formation modes,
the restricting unit prohibits image formation in the second image formation mode when the external storage device is designated,
the first image formation mode is a mode for forming, while scanning an image with the scanning unit, an image on the basis of image data obtained by this scanning and not requiring storage of the obtained image data after the image formation, and
the second image formation mode is a mode for forming, while scanning an image with the scanning unit, an image on the basis of image data obtained by this scanning and requiring storage of the obtained image data after the image formation.

5. An image forming apparatus according to claim 1, wherein
the image forming unit forms an image in a designated mode of first and second image formation modes,
the restricting unit prohibits image formation in the second image formation mode when the external storage device is designated,
the first image formation mode is a mode for forming, while scanning images from a series of plural originals set in the scanning unit, images on the basis of image data corresponding to the series of plural originals obtained by this scanning and not requiring storage of the obtained image data of the series of plural originals after the image formation, and
the second image formation mode is a mode for scanning images from a series of plural originals set in the scanning unit and forming, after storing image data corresponding to the series of plural originals obtained by this scanning, images of the series of plural originals on the basis of image data corresponding to the series of plural originals stored.

6. An image forming apparatus according to claim 5, wherein
the first image formation mode is a mode for outputting image data scanned from one original to one sheet, and
the second image formation mode is a mode for reducing image data scanned from plural originals and outputting the image data to one sheet.

7. An image forming apparatus according to claim 1, wherein
the image forming unit forms an image in a designated mode of first and second image formation modes,
the restricting unit prohibits image formation in the second image formation mode when the external storage device is designated,
the first image formation mode is a mode for forming, while scanning an image with the scanning unit, an image on the basis of image data obtained by this scanning and not requiring storage of the obtained image data after the image formation, and
the second image formation mode is a mode for forming, after repeating, a designated number of times, divisional scanning for scanning one original image set in the scanning unit with the original image divided into two and storing first and second image data corresponding to one original image obtained by this scanning, an image on the basis of image data stored according to the repetition of the divisional scanning for the designated number of times.

8. An image forming apparatus according to claim 1, wherein
the image forming unit forms an image in a designated mode of first and second image formation modes,
the restricting unit prohibits image formation in the second image formation mode when the external storage device is designated,
the first image formation mode is a mode for forming an image on the basis of image data received by the receiving unit and not requiring storage of the received image data after the image formation, and
the second image formation mode is a mode for forming, after storing image data received by the receiving unit, an image on the basis of the stored image data at a designated time.

9. An image forming apparatus according to claim 1, wherein
the image forming unit forms an image in a designated mode of first and second image formation modes,
the restricting unit prohibits image formation in the second image formation mode when the external storage device is designated,
the first image formation mode is a mode for forming an image on the basis of image data received by the receiving unit and not requiring storage of the received image data after the image formation, and
the second image formation mode is a mode for forming, after storing image data received by the receiving unit, an image on the basis of the stored image data with user authentication by input of user authentication information through the operation input unit as a condition.

10. An image forming apparatus according to claim 1, wherein the operation input unit displays one or plural image processing items corresponding to image processing not restricted by the restricting unit in a first display format, displays one or plural image processing items corresponding to image processing restricted by the restricting unit in a second display format different from the first display format, accepts and inputs operation for selecting a predetermined image processing item displayed in the first display format, and does not accept operation for selecting a predetermined image processing item displayed in the second display format.

11. An image processing operational control method comprising restricting predetermined image processing when, out of an internal storage device and an external storage device, the external storage device is designated.

12. An image processing operational control method according to claim 11, wherein image processing requiring a storage capacity exceeding a predetermined storage capacity is prohibited when the external storage device is designated.

13. An image processing operational control method according to claim 11, wherein
scanning of an image in a second scanning mode of first and second scanning modes is prohibited when the external storage device is designated,
the first scanning mode is a mode for scanning an image at a first resolution and storing the image, and
the second scanning mode is a mode for scanning an image at a second resolution higher than the first resolution and storing the image.

14. An image processing operational control method according to claim 11, wherein
image formation in second image formation mode of first and second image formation modes is prohibited when the external storage device is designated,
the first image formation mode is a mode for forming, while scanning an image, an image on the basis of image data obtained by this scanning and not requiring storage of the obtained image data after the image formation, and
the second image formation mode is a mode for forming, while scanning an image, an image on the basis of image data obtained by this scanning and requiring storage of the obtained image data after the image formation.

15. An image processing operational control method according to claim 11, wherein
image formation in second image formation mode of first and second image formation modes is prohibited when the external storage device is designated,
the first image formation mode is a mode for forming, while scanning images from a series of plural originals set, images on the basis of image data corresponding to the series of plural originals obtained by this scanning and not requiring storage of the obtained image data of the series of plural originals after the image formation, and
the second image formation mode is a mode for scanning images from a series of plural originals set and forming, after storing image data corresponding to the series of plural originals obtained by this scanning, images of the series of plural originals on the basis of image data corresponding to the series of plural originals stored.

16. An image processing operational control method according to claim 15, wherein
the first image formation mode is a mode for outputting image data scanned from one original to one sheet, and
the second image formation mode is a mode for reducing image data scanned from plural originals and outputting the image data to one sheet.

17. An image processing operational control method according to claim 11, wherein
image formation in second image formation mode of first and second image formation modes is prohibited when the external storage device is designated,
the first image formation mode is a mode for forming, while scanning an image, an image on the basis of image data obtained by this scanning and not requiring storage of the obtained image data after the image formation, and
the second image formation mode is a mode for forming, after repeating, a designated number of times, divisional scanning for scanning one original image set with the original image divided into two and storing first and second image data corresponding to one original image obtained by this scanning, an image on the basis of image data stored according to the repetition of the divisional scanning for the designated number of times.

18. An image processing operational control method according to claim 11, wherein
image formation in second image formation mode of first and second image formation modes is prohibited when the external storage device is designated,
the first image formation mode is a mode for forming an image on the basis of image data received from an outside and not requiring storage of the received image data after the image formation, and
the second image formation mode is a mode for forming, after storing image data received from an outside, an image on the basis of the stored image data at a designated time.

19. An image processing operational control method according to claim 11, wherein
image formation in second image formation mode of first and second image formation modes is prohibited when the external storage device is designated,
the first image formation mode is a mode for forming an image on the basis of image data received from an outside and not requiring storage of the received image data after the image formation, and
the second image formation mode is a mode for forming, after storing image data received from an outside, an image on the basis of the stored image data with user authentication by input of user authentication information as a condition.

20. An image forming apparatus comprising:
scanning means for scanning an image;
receiving means for receiving image data;
storing means for storing image data obtained by the scanning by the scanning means and image data received by the receiving means;
image forming means for forming an image on the basis of the image data stored in the storing means;
connecting means for connecting an external storage device;
operation inputting means for accepting and inputting operation of image processing desired by a user and various kinds of information;
designating means for designating one of the storing means and the external storage device connected by the connecting means; and
restricting means for restricting predetermined image processing when the external storage device is designated by the designating means.
